(19) United States
(12) Patent Application Publication
(10) Pub. No.: US 2021/0272164 A1
(43) Pub. Date: Sep. 2, 2021

(54) METHOD FOR PERFORMANCE-BASED PRICING IN OFFLINE MEDIA ADVERTISING

(71) Applicant: Rodrigo SANCHES, São Paulo - SP (BR)

(72) Inventor: Rodrigo SANCHES, São Paulo - SP (BR)

(21) Appl. No.: 17/258,350

(22) PCT Filed: Jul. 8, 2019
(86) PCT No.: PCT/BR2019/050256

§ 371 Date: Jan. 6, 2021

Related U.S. Application Data
(60) Provisional application No. 62/694,645, filed on Jul. 6, 2018.

(51) Int. Cl. G06Q 30/02

(52) U.S. Cl. CPC G06Q 30/0275; G06Q 30/0264; G06Q 30/0249; G06Q 30/0246

(57) ABSTRACT

This invention refers to a method for performance-based pricing in offline media advertising. This method allows the generation of performance metrics—or analytics—for offline media advertising, making it possible for vendors and advertisers to understand and optimize the actual results offline media campaigns generate. Through such metrics, becomes possible the practice of a dynamic pricing model, one in which the offline media vendor is paid according to the result it delivers to each advertiser. Such analytics are generated in real time, continuously, by a neutral, unbiased third-party platform, allowing offline media vendors and advertisers to trade based on these performance-based metrics. Such method comprises, in short: —a platform that connects offline media vendors and advertisers and their agencies; —a platform that measures the performance of offline media campaigns, through the measurement of customers' engagement; —a platform that allows media vendors and advertisers to reach a commercial deal through a process of dynamic pricing; —a platform that allows media optimization for both offline media vendors and advertisers.

### FIELD OF INVENTION

This invention refers to a method for performance-based pricing in offline media advertising (advertising on TV, radio, newspapers, magazines, billboards, etc). These methods allow price to be set based on the media performance generated by the offline media vendor (broadcaster, publisher or any offline media company) to the advertiser. Such dynamic pricing model allowed by the methods generates maximum efficiency in price setting, unlocking tremendous value for both media companies and advertisers. Such metrics are generated by a third-party platform, that also functions as a marketplace that brings together advertisers and media vendors that are interested in buying/selling offline media based on its actual and specific performance. The existence of a third-party entity specialized in the generation of offline media analytics allows not only the very metric to exist, but also the much-needed neutrality and impartiality related to fraud prevention and dispute resolution. In addition, these performance metrics are generated automatically and updated continuously in real-time, for both media companies and advertisers to monitor.

### STATE OF THE ART

It is known that advertising investment is one of the most significant lines of cost of companies that depend on their exposure to customers in order to sell. Such communication through media, especially offline media—that can impact millions of people simultaneously—has the goal of engaging customers, and make them react to an ad, therefore moving them closer towards a possible purchase. Customers can react to an offline media ad by going to a store, calling a phone number, or visiting a website. Therefore, the result of such media efforts, in other words, its performance, can be defined by the number of engagements it generates, since engagement is the key raw material of sales.

However, differently from what happens in online media (media on the internet), offline media vendors cannot produce any data related to the actual engagement the campaigns they publish generate for their advertisers. The only kind of data offered, which is the one all offline media markets practice—for the lack of a better, more precise and relevant option—is audience related data. This data is related to the number of people that watches a TV show, or tune in a radio station, for instance. It can also be enriched with demographic data, such as purchase power, level of education, etc. The issue is that this sample-based, generic, equal for all, static data has no capability whatsoever to indicate the actual engagement a media campaign produces. Two different advertisers can buy the exact same media plan, which, therefore, have the exact same audience data, but have two completely different results in terms of engagement.

Moreover, audience data does not allow for a sound rationale of pricing. That happens for two main reasons. Firstly, since advertisers are in fact looking for sales—therefore engagement—and since engagement is so poorly correlated with audience, high audience ads could be priced high while generating poor results, whereas low audience ads could be priced low while generating great results. Secondly, how could a specific audience of a TV show for instance, that has, say, 1 million viewers, explain a price of, for example, fifty thousand dollars for a 30 second commercial break? How could an audience-based metric explain this value of fifty thousand dollars should be the adequate price of this ad, as oppose to half of that price, or even double that price?

Furthermore, the current pricing model for offline media is always based on a price set by the media company, as oppose to one in which advertisers can bid for a space in the vendor's inventory. This current pricing model is inefficient for both media companies and advertisers, since, without the data intelligence created by the presence of performance metrics, broadcasters will have to price their programs in a pre-set, equal-for-all, fixed matter, regardless the result it will bring for the buyer (advertiser). That model prevents the maximization of revenue that can be generated from a given media inventory, since the media company has no means to forecast the maximum willingness to pay for each advertiser individually, given the fact it can only price its media based on audience, which is always the same for each advertising product, regardless the advertiser. The current model also prevents advertisers to bid for the engagement delivered. Bidding is known in microeconomic theory as the best way for sellers to capture value on any given asset. Not possible to be practiced in many industries, the generation of data will allow the offline media industry for the first time to engage in a model in which advertisers can bid for each response generated by its campaign in the broadcaster's inventory, and the media company to accept the offer or not, given its inventory availability and demand from other advertisers.

We highlight below some teachings of the state of the art that refer to this matter:

Document IE20160117 describes a form of measurement and recording of activity of Services/Assets of real life via application based on the web in which real-life goods can be evaluated and evaluated digitally from the moment they arrive on the market. It also deals with means of aggregating the value of the underlying assets/services by means of a financial digital reporting structure.

Further, document US2018075516 describes a neural embedding method to model the activity of a session. In this method, a data set can be collected in the online market, as an application store. Templates can be generated to represent session activity and therefore can be used for contextual application recommendations in an online application store. Item similarities and purchase forecasts can be used to provide real-time help to users who browse an online market.

Document US2008167949 describes a method by which the media presented for consumers can be evaluated as to the effectiveness and likelihood of success in the market. The method is to calculate the average selection of certain media presented to the consumers and use the average percentage of selection calculated in evaluating the probability of success of a similar media in the market. Companies can use the percentage of media selection to select the most effective media for their products. The selection of the media can also be used to connect people with similar interests as a social networking tool.

Document U.S. Pat. No. 9,697,503 describes computer-readable methods, systems, and media. An example of a method includes establishing a connection to a vehicle through a wireless network and associating the vehicle with a user account of a service online, in which a vehicle type for the vehicle is identified in the user's account. The method also includes the receipt of vehicle data for vehicle state information. The method includes access to one or more databases that include diagnostic data for the vehicle type and data of collective origin for the type of vehicle.

Document KR20090003989 describes a method of commercial transaction on-line advertising, making upload from the offline ad on an online site to increase the efficiency of work in real time by researching an advertising media and a cost. The advertisement of a media planner is registered in an advertising company responsible for a server. The advertising server company registers the advertisement on a site with a database server. The advertising server company transmits a search and purchase cost to the advertising server company and the advertising company transmits the media cost to the media planner, except the commission.

Document US2016189241 describes a computerized method of matching advertisement impressions for a particular campaign implemented on a trading platform/online digital advertisement market and implemented by at least one server that includes the step of receiving an insertion order (IO) advertising server, in which IO received in an electronic message communicated electronically to at least one server that implements the market platform/digital advertising exchange online. The process includes the step of determining a time expected on the screen to a digital ad. The process includes the step of determining a cost per second (CPS) in which digital propaganda should be displayed on a computer screen, in which the CPS is a measure of once a computer screen is controlled by a digital advertisement display. The process includes the calibration step, in an algorithmic way, an advertising campaign that comprises the digital ad, in which the digital advertisement is provided for display in a specified number of impressions per period of time specified during the period of the advertising campaign.

Therefore, it does not exist in the state of art solution equivalent to the one presented here in this invention, that make it possible for offline media companies to offer precise, real-time and unbiased performance metrics for their advertising customers' campaigns, allowing them, for the first time, to practice a pay-per-performance model, which was a possibility only for online media companies.

### OBJECTIVES OF THE INVENTION

So, it is an objective of this invention to provide a method of negotiation between an offline media vendor and an advertiser (or its advertising agency that represents it) that allows the media vendor to be paid according to the actual result it provides to that specific advertiser.

It is another of the objectives of this invention to provide a means (platform) that allows offline media advertisers to bid a price for the engagement (response) yielded by the offline media vendor. This platform also brings important data such as the maximum investment amount and broadcasting period set by the advertiser, allowing the media vendor to have all necessary information to either accept or decline the bid.

It is another of the objectives of this invention to provide a method to allow the definition of a response price (the price for each engagement generated, such as a store visit, a website visit, or a phone call), that is dynamic and optimum for each specific advertiser, at each specific point in time. This data-driven price differentiation approach, known as Revenue Management, allows for tremendous gains for vendors, by maximizing their revenues, as well as for advertisers, by guaranteeing an equitable serving of the market, directing the offer to the ones that can make the best use of it, factors that bring new levels of efficiency to the whole offline media market.

It is another of the objectives of this invention to provide an additional form to offline media vendors to price their offerings, one based out of the quantity of engagements it can deliver to an advertiser.

It is another of the objectives of this invention to provide advertisers and their agencies with the means to understand and maximize the efficiency of their own creatives (ads), allowing the media vendor to produce even better results, since results come from both ideal programming (which is a vendor's responsibility in the invention's method) and ideal creative (which is an advertiser's responsibility).

It is another of the objectives of this invention to bring a third-party, unbiased entity to generate and assure the accuracy of the performance data. Since the offline media vendor will be paid according to the performance it delivers, the vendor is not a neutral party to provide performance data. Nor is the advertiser, for the same reason. Third-party data generation and auditing allows the necessary trust for the system to work properly, such as the trust brought by a trading platform such as the New York Exchange, that stands between the buyer's interest in paying low and the seller's interest in selling high.

### SUMMARY OF THE INVENTION

The present invention achieves these and other objectives by means of a method for performance-based pricing of offline media advertising that comprises the following steps:
a) Creation of a virtual trading platform (marketplace) for the communication between at least one advertiser and at least one offline advertising media vendor;
b) Electronic submission of a “Performance Purchase Request” comprising a bid for the response price, an investment limit, a campaign beginning date and a campaign end date, as well as other information;
c) Analysis of the PPR (Performance Purchase Request) by the vendor, with the option of doing it through the platform's intelligent revenue management algorithms;
d) Electronic submission to the advertiser of the vendor's response to the PPR;
   If the PPR is declined by the vendor, a platform's algorithm can suggest the vendor the best counter-offer to be made. If the PPR is accepted by the vendor, a tag-embedded creative (ad) is produced by the advertiser, that will be electronically submitted through the platform to the vendor, so that the ad can be aired/published, and analytics can be generated;
e) Preparation of the PPR's delivery plan (media plan) by the vendor, in order to actually generate the responses it will be paid for;
f) Broadcasting/publishing of the advertiser's campaign by the offline media vendor, with real-time performance metrics being generated by the platform;
g) Ending of the PPR when it reaches either the advertiser's investment limit, or the campaign's end data, whichever comes first;
h) Continuous storage of all data for both vendor and advertiser to access.

### DETAILED DESCRIPTION OF THE INVENTION

The present invention was developed based on the fact that, opposite to online media, offline media cannot provide analytics. For that reason, it is not possible for offline media to be priced according to the actual result advertisers get. This fact creates many problems:

1. Media vendors cannot practice real price differentiation strategies. Without performance analytics, the price of a particular media product is the same for everyone. Because of that, media vendors lose revenue opportunities:

a) with all advertisers that would buy only if the price was lower, and

b) with all advertisers that would agree to pay more, given the results obtained through the media.

In addition, dynamic pricing provides a much more efficient alignment between the vendor's capability to deliver engagement, and the advertisers that will make the best use of it, which are the ones willing to pay higher prices, hence prioritizing inventory for them.

2. The current model does not allow media vendors to use data intelligence to maximize the performance of their inventory (for example, the 24 hours of a TV channel programming). Through analytics, media companies will be able to understand with great precision the engagement generated off of its inventory by each type of advertiser, with each type of ad, in each particular segment, program, etc, on each particular market, in each particular time of year. That kind of sound, precise, specific data allows for a great deal of optimization, since the vendor can now allocate ads in a much more intelligent way across all its media products, maximizing engagement, and minimizing inventory usage.

3. The current model does not allow media vendors to materialize the results they deliver to advertisers, since there is no performance data available, let alone offer specific data for each campaign, each advertiser, each creative (ad), at any given time. In other words, a new campaign starts, and no specific data is generated. The audience data that can be related to the campaign's media plan already existed before the beginning of the campaign, and will change in nothing because of the campaign, since the audience data refers to the vendor's audience given a specific media plan, and not the advertiser's results from that campaign. The existence of performance metrics for offline media makes it a much more compelling and attractive solution for advertisers. Also, it allows advertisers to be able to value media in a much more effective way, since it becomes possible to estimate with much greater precision the media overall return-on-investment compared to any other investment alternatives.

Considering the topics described above, the present invention was developed and refers to a method for offline media advertising performance-based pricing. In a first preferred embodiment, this method comprises the following steps:
a) Creation of a virtual trading platform (marketplace) for the communication between at least one advertiser and at least one offline media vendor;
b) Electronic submission of a “Performance Purchase Request”, which is a proposal by the advertiser to the vendor referred to an advertising campaign, comprising of a bid for the response price (price the advertiser is willing to pay for each engagement), an investment limit (maximum amount of money the advertiser is willing to spend with the media, which is the response price times the number of responses), a campaign beginning date (date before which the vendor cannot air the campaign), and a campaign end date (date after which the vendor cannot air the campaign), as well as other data;
c) Analysis of the PPR (Performance Purchase Request) by the vendor, with the option of doing it through the platform's intelligent revenue management algorithms;
d) Publishing of the electronic response of the PPR by the vendor to the advertiser;
e) If declined, the algorithm can suggest the best counter-offer and if accepted, a tag-embedded creative (ad) is produced by the advertiser, that will be electronically submitted through the platform to the vendor, so that the ad can be aired/published, and analytics can be generated. The tags may be provided to advertisers automatically by the platform;
f) The preparation of the PPR's delivery plan (media plan) by the vendor, in order to generate the response that it will be paid for. This can be done using the platform's intelligent revenue management algorithms, that will define the dates, frequency and programs to be used by the vendor to most effectively achieve its delivery goals;
g) Broadcasting/publishing of the advertiser's campaign by the offline media vendor, with real-time performance metrics being generated by the platform. Monitoring can happen simultaneously by both vendor and the advertiser and its agency through real-time electronic reports available in the platform.
h) Ending of the PPR when it reaches either the advertiser's investment limit, or the campaign's end data, whichever comes first.
i) Continuous storage of all data for both vendor and advertiser, so PPRs' results can be tracked over time and analyzed for intelligence and optimization purposes.

Once performance metrics for offline media can be generated, and there is a platform that brings together advertisers and media companies allowing them to trade based on performance, then the three great challenges for offline media are resolved:
a) to make advertisers' actual and specific results tangible,
b) to allow broadcasters to practice a pricing model in which advertisers pay according to the results they get, and
c) to allow both media vendors and advertisers (and their agencies) to work with data intelligence in order to drastically increase efficiency and results.

The applicant stands out that the present invention allows offline media companies to enter the world of analytics, of data science, by not only making it possible for the data to exist, but also for it to be used in a way that creates a new level of efficiency to the whole offline advertising ecosystem. Through this invention, offline media advertisers can now understand the engagement their creatives (ads) generate, allowing them to learn what should be done for ads to generate more engagement over time (this is the process called optimization, never before possible for offline media).

Optimization becomes possible for offline advertising media vendors as well, because it can now understand the performance of each program, content, section, has towards the generation of engagement for each specific advertiser, and each specific ad, allowing them to reorganize the way they broadcast/publish their clients' ads so they can generate maximum efficiency (engagement) with minimum effort (usage of media time or space).

The invention also makes it possible for media companies to practice a completely new approach in terms of pricing, known as Revenue Management. This pricing practice is based on the setting of very different price points to different customers for the same product offering, according to each customer's “willingness to pay”. The most common example is airfare pricing. Tickets for the very same flight are sold at completely different prices, according to the customer's profile (which indicates its willingness to pay). This approach guarantees an enormous efficiency gain for all involved, in the sense that price tends to be always right—never too expensive, turning customers away, and never too cheap, remunerating media companies less than the value they create, and leaving customers unattended by attracting more customers than the ones media companies have the ability to serve. And that highly differentiated, near-perfect pricing the invention allows to be possible happens simultaneously for each kind of offering, for each advertiser, in each moment over time. That price flexibility is critical for industries in which product cannot be stored, such as seats on a flight or rooms in a hotel. If a flight seat or hotel room goes by without a patron, the revenue it could create is lost forever. Offline media has exactly that same behavior—if a commercial break happens and an ad is not sold, that opportunity is gone forever.

However, even though the practicing of such pricing strategy would create incalculable value, it could not be achieved without the existence of performance data or the methods encompassed in the invention.

Therefore, the invention brings a new dimension of possibilities to offline advertising media companies and their clients (advertisers), allowing them to enter a new world of efficiency and performance like never before.

It should be emphasized that it is understood by offline media all the media that is not online media (also known as digital media or media on the internet). Therefore, examples of offline media advertising are advertising on TV, radio, newspapers, tabloids, pamphlets, magazines, billboards, panels (either electronic or static), ads in movie theaters, as well as in any out-of-home media such as buses, taxis, in-store displays, etc.

Therefore, the terms “air”, “publish”, “broadcast” should be understood as synonyms for the purpose of the present invention since they have as meaning the act of disclosing or showing the advertisement or advertising campaign in all known offline media.

The consumer engagement measured is any form of interest expressed by the consumer after watching or hearing a certain advertising campaign aired in offline media. Notably, the act of vising the advertiser's store, its website or calling its phone number.

To then measure the engagement, the advertisers' campaigns include measurement tags in their creatives (ads). Such tags are designed to precisely measure the responses the campaign is getting from consumers, and they are provided by the platform comprised in the invention. These tags are selected phone numbers, domain names or instant messages (such as in S.M.S, Facebook Massager, Twitter, WhatsApp or others).

The applicant informs that such tags, in preferred embodiments, may be produced as disclosed in PCT patent application PCT/BR2019/050009 filed by the own applicant.

Consumers watch a content, such as a TV show, and, at some point, see an ad. He or she can then call a phone number, go visit a store, or send an instant message, based on what was communicated in the commercial. Every single response that is the result of a customer's engagement will be captured and accounted for in real time for both vendor and advertiser to see. All this data is computed in an integrated fashion, on a single platform, enabling a wide array of analysis.

The platform should be unique to consolidate all the data and all the analyses in order to provide reliable, traceable, and verifiable returns.

The data captured is treated using an array of specific algorithms. Preferably, these algorithms comprises artificial intelligence. Thus, the algorithms treat all primary data from all referenced sources resulting in the generation of much richer, insightful and actionable knowledge. All data is stored in interconnected multidimensional databases, in which it is possible to perform various types of cross-information analysis, not possible otherwise. That is why such steps are only feasible to be performed on a computational device.

This data represents in detail the consumers' engagement from the ads in the communication strategy adopted. It reveals their behavior prompted by the advertising piece comprising the chosen measurement tag. This rich data is highly relevant to the agents of the communication ecosystem (advertisers, agencies, offline media vendors and the like).

Such data results in much more than information received, being Information for management and decision-making, allowing structural performance gains.

Therefore, with all this information captured and treated, it is possible to generate performance metrics for offline media campaigns.

These metrics, or analytics, are fundamental to optimum media price setting, creating enormous value for both offline media vendors and advertisers.

Through the practice of such dynamic pricing, it is possible to eliminate the use of fixed pricing tables, as well as the sometimes endless discussions of discounts—that so often happen without the support of any sound rationale—which allows a much more agile, assertive and effective deal conduction.

Further, such metrics are calculated by a third party other than the media vendor or the advertiser, which confers exemption, impartiality and neutrality of the data provided.

The use of performance analytics allows both advertisers and media companies to be more and more efficient in their dealings over time, through the accumulation of data intelligence coming from the continuous generation of data.

Preferably, such indexes do not reveal specific data of the parties to preserve sensitive information.

It is noted that preferably the metrics (or indexes) of performance are calculated based on the following steps:
I. Capturing the general public's engagement data from consumers;
Ii. Processing data captured using specific algorithms that evaluate the performance of the advertising campaign;
Iii. Data monitoring and updating of the parameters and indexes used in performance metrics.

In preferred embodiments, anti-fraud algorithms are also used to verify the veracity of the consumer's engagement, and to eliminate divergences, distortions, or any intention from any party to either inflate or deflate results.

In an alternative variation of the present invention, the electronic submission of a “Performance Purchase Request” comprised on item b) of the method of the present invention is a proposal made by the vendor to the advertiser, which also comprises a bid for the response price (price the advertiser is will pay for each engagement), and that can additionally suggest an investment limit (maximum amount of money the advertiser is willing to spend with the media, which is the response price times the number of responses), a campaign beginning date (date before which the vendor cannot air the campaign), and a campaign end date (date after which the vendor cannot air the campaign), as well as other data.

And, in this version, the analysis of the PPR (Performance Purchase Request) is performed by the advertiser. As in the original embodiment of the invention, a PPR could be offered either to many counter-parties simultaneously, or to a specific one.

This is another innovative factor. Now it becomes possible for the vendor to propose a calculated value based on the engagement to serve an advertising campaign for an advertiser. The possibilities of negotiation between the parties increase significantly as there is flexibility and exempt data to drive deals to happen.

The advertiser, in turn, can accept the proposal, decline it or submit a counter-offer.

According to the present invention, advertisers can choose any media vendor that is present in the marketplace (platform) to place a PPR (Performance Purchase Request). The PPR becomes an effective media purchase order the minute the vendor accepts it. The vendor has a limited amount of time (for example, 48 hours) to either decline (with or without a counter-offer) or accept the PPR. If the vendor fails to respond within that time period, the PPR becomes ineffective and the advertiser is free to allocate its budget in another vendor, through a new PPR. Since the PPR is a binding offer on the advertiser's end, such time limiting feature guarantees the advertiser the necessary freedom to relocate its budget in case a vendor does not respond to its PPR.

In the unlikely event of conflict between the parties, it is possible to ask the platform for mediation, which, as the neutral party, has the final word regarding the dispute.

This invention presents numerous technical and economic advantages when compared with the state of the art, being some listed below:
the invention makes possible for offline media to produce actual analytics, in other words, real-time, precise, specific, non sample-based, reliable data about the results offline media advertising generates to each particular advertiser, in each specific situation;
the invention makes possible the practice of a new pricing model for offline media companies, one based on the actual performance it delivers to advertisers, adding tremendous impact to the value proposition of their offerings in the market;
the invention makes possible the practice of a new pricing model for offline advertising media companies, one based on the actual performance it delivers to advertisers, guaranteeing optimum price setting through dynamic pricing, and adding tremendous impact on the ability of an offline media vendor to maximize revenue;
the invention makes possible the practice of a new pricing model for offline advertising media companies, one based on the actual performance it delivers to advertisers, making markets more efficient by strongly fostering the allocation of media inventory to advertisers that are able to generate more value through this inventory, therefore more capable of paying higher prices;
the invention makes possible for advertisers to now have the necessary data and the economic incentives to understand and optimize their creatives (ads), meaning they will be able produce ads that engage more over time. This help media vendors to generate more responses, which in turn helps bringing response prices down, which in turn fosters more media investments from advertisers, creating a virtuous cycle that brings the whole system to new, much more efficient equilibrium;
the invention makes possible for offline media companies to have the data intelligence and the economic incentives needed to heavily optimize their inventories, in other words, to produce more consumer engagement over time from the ads they air, given an available audience;
the invention makes possible for advertisers to be much more efficient in determining the right offline media budget for their corporations, provided they now have the necessary data to better understand the actual value offline media advertising have for them. That allows setting the right amount of financial resources, not more, not less, to guarantee maximum return on investment regardless the context;

the invention makes possible for advertisers to, given an offline media budget, to optimally allocate it across different vendors. Once advertisers are capable of understanding the price per response vendors practice and also the amount of responses vendors can generate, they have the ability to choose the ideal investment to be placed in each vendor;
the invention makes possible for advertisers and vendors to optimize results and fine tune negotiations by working with the PPR parameters;
the invention makes possible for an almost total elimination of the risk involved in buying offline media advertising, allowing advertisers to pre-set both the response price and the amount of demand (responses) to be achieved (as a consequence of the investment limit). Now vendors can sell, and advertisers can buy offline media in a virtually risk-free, success-guaranteed fashion. This alone has the potential of binging an efficiency shock to offline media markets, since the elimination of risk brings huge value to all parties in an ecosystem, notably, in this case, media companies, advertisers and their agencies;
the invention makes possible for offline media vendors to actually materialize the results they provide to advertisers, making these results tangible through the existence of efficiency metrics, making their offering more fact-based, data-driven, and more appealing to the market;
the invention makes possible for offline media vendors to optimize their content production. Since they can now understand the amount of engagement each show, program, section or area generates, as well as the price of the responses each kind of content commands in the market, the vendor can start to produce more of the kind of content that generates the most revenue. Or for an out-of-home media vendor, for instance, go after real estate that is similar to the areas they are able to drive the most revenue from. The invention, therefore, allows the choices a vendor makes in terms of content to be much more data-driven and effective;
the invention makes possible for a much better usage of media installed capacity, unlocking tremendous value to all the ecosystem. Nowadays most offline media vendors have a high percentage of available advertising inventory, which is not sold fundamentally for the reason of a non-compelling value proposition (as explained above). By allowing this dynamic to change, all this high-value asset will become available to be used by advertisers to generate value for them, which, in turn, generates value for vendors, trickling down to the whole market;
the invention makes possible for predictive algorithms to be used for both the benefit of vendors and advertisers alike. It becomes possible to use sophisticated mathematical approaches to efficiently predict media demand over time, response prices and volumes, allowing vendors and advertisers to prepare accordingly, preventing or minimizing the effects of media inventory shortages or excess demand, for instance;
the invention makes possible for vendors and advertisers to actually execute all the advantages described above, by the existence and constant maintenance and management of a platform that brings all the functionalities needed for such actions, namely (just to name a few), all the necessary steps to make tags available and passive to configuration, all the hardware, software and infrastructure to produce, process e display the analytics, all the reports and user interface, alerts, all policies and rules, data protection guarantees and safeguards, creative delivery features, legal procedures, data safety, user security, status and authentication, contracts for the different parties in the marketplace, usage policies, and so on.
Having been described as an example of a preferred embodiment of this invention, it must be understood that the scope of this invention covers other possible variations of the inventive concept described, being limited only by the content of the claims including the possible equivalents.

1. A method for performance-based pricing of offline media advertising characterized by comprising the following steps:
a) creation of a virtual trading platform (marketplace) for the communication between at least one advertiser and at least one offline media vendor;
b) electronic submission by the advertiser of a “Performance Purchase Request” comprising a bid referred to an advertising campaign's response price, an investment limit, a campaign start date and a campaign end date, as well as other data;
c) analysis of the PPR (Performance Purchase Request) by the vendor, with the option of doing it through the platform's intelligent revenue management algorithms;
d) electronic disclosure of the vendor's response of the advertiser's PPR;
e) if declined, the algorithm can suggest the best counter-offer and if accepted, a tag-embedded creative (ad) is produced by the advertiser, that will be electronically submitted through the platform to the vendor, so that the ad can be published, and analytics can be generated;
f) preparation of the PPR's delivery plan (media plan) by the vendor, in order to generate the responses that it will be paid for;
g) publishing of the advertiser's campaign by the offline media vendor, with real-time performance metrics being generated by the platform;
h) ending of the PPR when it reaches either the advertiser's investment \limit, or the campaign's end data, whichever comes first; and
i) continuous storage of all data for both vendor and advertiser.

2. The method according to the claim 1, characterized by an advertising campaign comprising a measurement tag relating to a promotional campaign.

3. The method according to the claim 1 characterized by the measurement tag being selected from phone numbers, domain names and instant messages, and possible combination among them.

4. The method according to the claim 3 characterized by a consumer engaging an ad measured by a measuring tag, via landline phone, computer, cell phone, tablet, physical visit to store, website, wearable devices or any other means.

5. The method according to claim 1 characterized by the performance metrics is calculated based on the following steps:
i. capturing the general public's engagement data from consumers;
ii. processing data captured using specific algorithms that evaluate the performance of the advertising campaign; and
iii. data monitoring and updating of the parameters and indexes used in performance metrics.

6. The method according to claim 1 characterized by the performance metrics being calculated by algorithm developed with exemption and neutrality.

7. The method according to claim 1 characterized by:
the response price refers to a price the advertiser is willing to pay for each engagement,
an investment limit refers to a maximum amount of money the advertiser is willing to spend with the media, which is the response price times the number of responses,
a campaign beginning date refers to a date before which the vendor cannot air the campaign, and
a campaign end date refers to a date after which the vendor cannot air the campaign.

8. The method according to claim 1 characterized by the tags produced on item c) being provided to advertisers automatically by the platform.

9. The method according to claim 1 characterized by item f) can be done using the platform's intelligent revenue management algorithms, that will define the dates, frequency and programs to be used by the vendor to most effectively achieve its delivery goals.

10. The method according to claim 1 characterized by item g) also comprising:
simultaneous monitoring by both vendor and the advertiser and its agency through real-time electronic reports available in the platform.
